(19) United States
(12) Patent Application Publication
(10) Pub. No.: US 2008/0001518 A1
(43) Pub. Date: Jan. 3, 2008

(54) Electrodeless phototherapy lamp

(75) Inventors: Robert Martin, Nicolasville, KY (US); Arunava Dutta, Winchester, MA (US); Aline Tetreault, Kingsey Falls (CA)

Correspondence Address: OSRAM SYLVANIA INC, 100 ENDICOTT STREET, DANVERS, MA, 01923, US

(73) Assignee: OSRAM SYLVANIA, INC, DANVERS, MA (US)

(21) Appl. No.: 11/798,818

(22) Filed: May 17, 2007

Related U.S. Application Data
(60) Provisional application No. 60/801,157, filed on May 17, 2006.

(51) Int. Cl. H01J 1/63

(52) U.S. Cl. 313/486

(57) ABSTRACT

A photo-therapeutic, electrodeless lamp comprises a closed-loop envelope containing an arc generating and sustaining medium. A phosphor coating on the interior of the envelope generates visible radiation in response to excitation from 254 nm radiation. The visible radiation has an energy output in the region of 500-800 nm of ≧12,000 μW/cm^{2.A} reflector formed on a portion of the envelope leaves a window for the emission of the visible radiation and concentrates the power requirements. Means are formed with the lamp for supplying RF excitation to generate the 254 nm radiation. The lamp has an effective area that allows easy operator manipulation and good patient access.

### CROSS-REFERENCE TO RELATED APPLICATION

This application claims priority from Provisional Patent Application Ser. No. 60,801,157,filed May 17, 2006.

### TECHNICAL FIELD

This invention relates to electrodeless fluorescent lamps and more particularly to such lamps for use in phototherapy.

### BACKGROUND ART

Phototherapy is used in the medical community to treat, among other conditions, various skin disorders. The treatment consists primarily of giving particular medicines to a patient and subsequently activating these medicines by irradiating the patient with specific visible or non-visible (for example, UV) radiation. To produce the desired radiation various light sources have been employed. Important features of these light sources include: radiated power; power bandwidth, power homogeneity; power depreciation of time (also referred to as maintenance). The various light source previously employed generally comprise elongated fluorescent tubing which, while workable, present obvious handling problems.

### DISCLOSURE OF INVENTION

It is, therefore, an object of the invention to obviate the disadvantages of the prior art.

It is another object of the invention to alleviate prior shortcomings in the treatment of diseases.

These objects are accomplished, in one aspect of the invention, by the provision of a photo-therapeutic, electrodeless lamp comprising: a closed-loop envelope containing an arc generating and sustaining medium; a phosphor coating on the interior of said envelope capable of generating visible radiation in response to excitation from 254 nm radiation, said visible radiation having an energy output in the region of 500-800 nm of ≧12,000 μW/cm²; a reflector formed on a portion of said envelope leaving a window for the emission of said visible radiation; and means formed with said lamp for supplying RF excitation to generate said 254 nm radiation.

The electrodeless lamp has a long life expectancy and can meet the desired power requirements.

### BRIEF DESCRIPTION OF THE DRAWINGS

FIG. 1 is a side, elevational view of an electrodeless lamp according to an aspect of the invention;

FIG. 2 is a plan view thereof; and

FIG. 3 is a graph of the spectral power distribution of the lamp with a particular phosphor.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

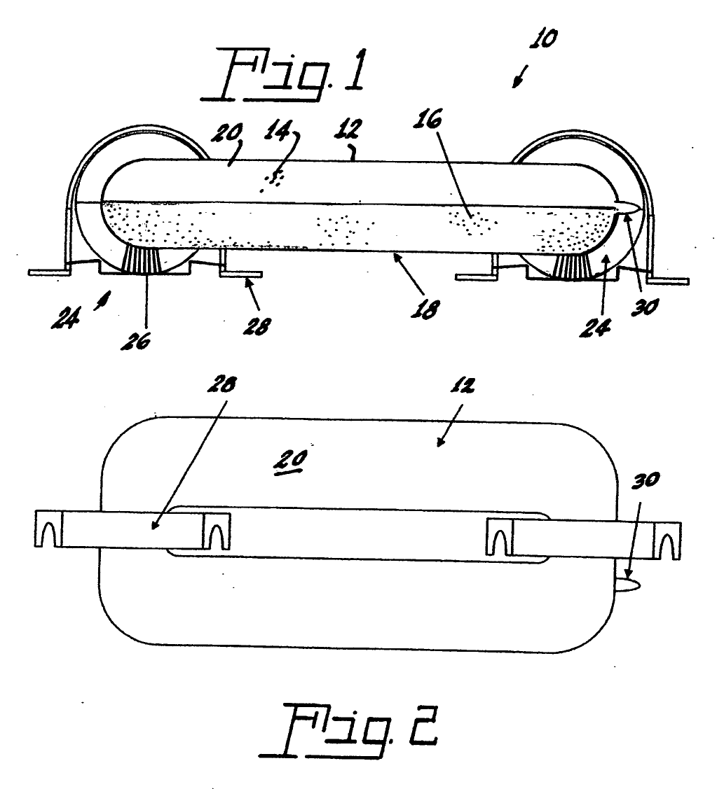

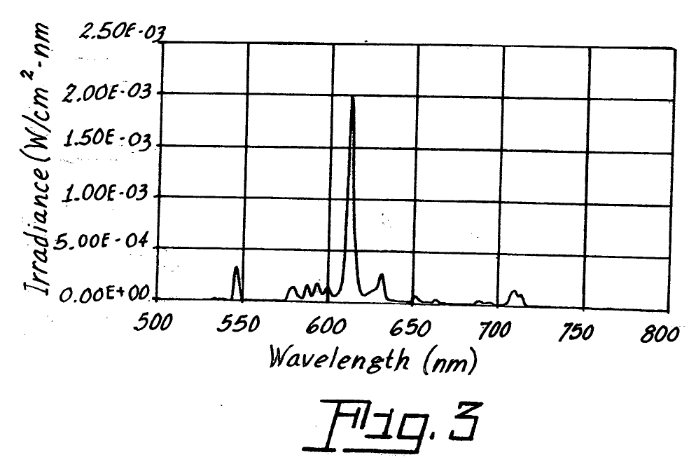

Referring now to the drawings with greater particularity, there is shown in FIG. 1 a photo-therapeutic, electrodeless lamp 10 comprising a closed-loop envelope 12 containing an arc generating and sustaining medium that includes mercury. A phosphor coating 14 is provided on the interior surface of the envelope 12. The phosphor coating is capable of generating visible radiation in response to excitation from 254 nm radiation and provides visible radiation having an energy output in the region of 500-800 nm of ≧12,000 μW/cm^{2.} In a preferred embodiment of the invention the phosphor is Y₂O₃:Eu, which has a spectral response with a peak at 611 nm with a band width of 0.6 nm; however, other phosphors, such, for example, as Gd(Zn,Mg)B₅O₁₀:Ce, Mn, Mg₄(F)GeO₆:Mn or Mg₄(F)(Ge,Sn)O₆:Mn or mixtures of phosphors can be used to provide the desired radiation. The phosphor that generated the results shown in FIG. 3 is Y₂O₃:Eu, and perusal thereof will show that the total flux in the 500-800 nm region is about 13,375 μW/cm².

A reflector 16 is formed on a portion 18 of the envelope 12 leaving a window 20 for the emission of the visible radiation. The reflector 16 is important to increase the radiated power from the lamp for therapeutic purposes and can be applied to the interior or exterior of the envelope. The reflector layer preferably comprises a powder possessing the appropriate material characteristics so as to reflect the visible radiation towards the lamp window 20. The powder loading of the reflector can vary between 5-15 mg/cm² and when the Y₂O₃:Eu phosphor is used the reflector material is preferably alpha alumina with a preferred loading of 7-12 mg/cm².

Conventional means 24 are formed with the lamp 10 for supplying RF excitation to generate the 254 nm radiation and comprise magnetic cores with windings 26. Such means are shown, for example, in U.S. Pat. No. 5,834,905, which is assigned to the assignee of the present invention and whose teachings are herein incorporated by reference. The lamp 10 can conveniently be supported by aluminum fittings 28. An amalgam tip 30 allows for evacuation and filling of the lamp and can provide a repository for the amalgam that is a part of the arc generating and sustaining medium.

In a preferred embodiment of the invention the envelope has dimensions of about 250 mm×137 mm and thus encompasses an area of about 342.5 cm², this area being sufficient to cover an entire side of a patient's face, for example.

The discharge generated within the envelope 12, in addition to the desired 254 nm excitation also produces radiation at 185 nm and the latter radiation is known to degrade the phosphors within the envelope and thus shorten the life of the lamp. To avoid this effect an alumina coating is provided on the phosphors, this coating absorbing the 185 nm radiation but passing the desired 254 nm radiation to activate the phosphor.

The electrodeless lamp 10 inductively couples RF energy, supplied by an RF source, through the magnetic cores and it is the absence of electrodes that increase the life of the electrodeless lamp well beyond the life of normal fluorescent lamps, which employ electrodes for supporting the electrical discharge.

Thus there is provided a therapeutic lamp that has long life expectancy and a controlled, homogeneous radiation output in a practical pattern that enables excellent operator control in manipulating the lamp in close proximity to a patient.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A photo-therapeutic, electrodeless lamp comprising:
a closed-loop envelope containing an arc generating and sustaining medium;
a phosphor coating on the interior of said envelope, said phosphor coating being capable of generating visible radiation in response to excitation from 254 nm radiation, said visible radiation having an energy output in the region of 500-800 nm of ≧12,000 μW/cm²;
a reflector formed on a portion of said envelope leaving a window for the emission of said visible radiation; and
means formed with said lamp for supplying RF excitation to generate said 254 nm radiation.

2. The lamp of claim 1 wherein said envelope encompasses an area of about 342.5 cm².

3. The lamp of claim 1 wherein said phosphor is Y₂O₃:Eu.

4. The lamp of claim 1 wherein said phosphor is Gd(Zn,Mg)B₅O₁₀:Ce, Mn.

5. The lamp of claim 1 wherein said phosphor is Mg₄(F)GeO₆:Mn.

6. The lamp of claim 1 wherein said phosphor is Mg₄(F)(Ge,Sn)O₆:Mn.

7. The lamp of claim 1 wherein said visible radiation is in the region of 600-660 nm.

8. The lamp of claim 1 wherein said visible radiation is in the region of 600-620 nm and has a bandwidth of 0.5-1 nm.
